(19) United States
(12) Patent Application Publication
(10) Pub. No.: US 2008/0055491 A1
(43) Pub. Date: Mar. 6, 2008

(54) Cabinet with movable video screen

(75) Inventors: Timothy Alexander Gordon, Moncton (CA); Julien Grell, Moncton (CA); Steven McKeown, Moncton (CA); Jean-Frederic Roy, Dieppe (CA); Todd Smith, Moncton (CA)

Correspondence Address: KENYON & KENYON LLP, ONE BROADWAY, NEW YORK, NY, 10004, US

(73) Assignee: Spielo Manufacturing ULC.

(21) Appl. No.: 11/702,978

(22) Filed: Feb. 5, 2007

Related U.S. Application Data
(60) Provisional application No. 60/771,132, filed on Feb. 6, 2006.

(51) Int. Cl. H04N 5/64; G06F 17/00

(52) U.S. Cl. 348/836; 463/20; 348/E05.128

(57) ABSTRACT

A video terminal may be provided. The video terminal may include internal hardware. The video terminal may include a cabinet, the cabinet enclosing the internal hardware. The video terminal may include a door movably attached to the cabinet, the door having a door opened and a door closed position. The video terminal may include a display screen movably attached to the cabinet separately from the door and having a screen opened and a screen closed position.

### BACKGROUND

Lottery games may be provided at a video terminal where players can buy tickets, view a list of available prizes, and handle basic customer service transactions. Other lottery games may be played directly on a display screen of a video terminal. One type of video terminal used in wagering games is a video lottery machine. Video lottery machines may include a cabinet enclosing internal hardware and a display screen visible to a user. Internal hardware may include hardware and software controls for playing a wagering game, such as a lottery game. Information may be displayed on the display screen. For example, the provided controls can cause a display of the lottery tickets available, attractive animation sequences to promote sales, and accept a selection of lottery tickets to purchase.

Many other wagering games may also use a video terminal. For example, a video terminal may be configured to provide a game of video poker. The provided controls may cause cards to be displayed on the screen, along with other game play information such as bet information and a prize structure for particular poker hands. Other wagering games that may use a terminal including video slot machines and video blackjack machines.

Cabinets enclosing a display screen and internal hardware are typically large in order to allow access to the internal hardware for maintenance and upgrades. Some types of repairs may require removal of the display screen in order to gain access to internal hardware located behind the display screen. Alternatively, cabinets may mount the display screen on a hinged door. The door may open outwards, allowing access to the internal hardware. Opening the door swings it outwards and moves the display screen out of easy access by a technician. Reducing service time and simplifying service access is important, particularly given the large number of video terminals that may be installed by a gaming provider.

### BRIEF DESCRIPTION OF THE DRAWINGS

FIG. 1 depicts a perspective view of an example video game terminal in a closed position, in accordance with an embodiment of the present invention.

FIG. 2 depicts a perspective view of an example video game terminal in an opened position, in accordance with an embodiment of the present invention.

FIG. 3 depicts a side view of an example video game terminal in a half-opened position, in accordance with a first example embodiment of the present invention.

FIG. 4 depicts a side view of an example video game terminal in an opened position, in accordance with a first example embodiment of the present invention.

FIG. 5 depicts a side view of an example display screen assembly, in accordance with an example embodiment of the present invention.

FIG. 6 depicts a front view of an example display screen assembly, in accordance with an example embodiment of the present invention.

FIG. 7 depicts a perspective view of an example display screen in a closed position within an example video game terminal without a door, in accordance with an embodiment of the present invention.

FIG. 8 depicts an exploded perspective view of an example display screen assembly, in accordance with an example embodiment of the present invention.

FIG. 9 depicts a side view of a second example video terminal in a half-opened position, in accordance with a second example embodiment of the present invention.

FIG. 10 depicts a side view of a second example video game terminal in an opened position, in accordance with a second example embodiment of the present invention.

### DETAILED DESCRIPTION OF EXAMPLE EMBODIMENTS

Example embodiments described here are generally intended for use in video gaming terminals, video lottery terminals, video slot machines and similar applications, although it will be appreciated that they may find application in other terminal or kiosk applications. These example terminals include a cabinet with a locking door, internal electronic hardware and a display screen. When the door is opened, the display screen moves out of the way to allow access to the internal electronic hardware. This may be accomplished by mounting the screen on a set of rollers, the set of rollers configured to run within a set of guides. The display screen may be operably attached to the door so that when the door is opened, it pulls the screen along the roller and guide assembly to an opened position. The example embodiments allow both access to the internal peripherals and the display screen at the same time.

An example embodiment of the present invention may be a video terminal that is physically small with a large display screen. The terminal may include a cabinet secure against unauthorized access that substantially encloses a video lottery terminal and the display screen. The cabinet may include a display screen operably connect to the video lottery terminal, the display screen used to display output information. The cabinet may include a door that opens outwards. When the door is opened, the display screen may be moved to provide access to internal peripherals of the video lottery terminal for upgrade and maintenance. The cabinet may be configured to keep the display screen accessible to a user when the door is opened.

Another example embodiment of the present invention may be a video terminal, including internal hardware, a cabinet, a door movably attached to the cabinet, and a display screen movably attached to the cabinet separately from the door and having a screen opened and a screen closed position. The cabinet may enclose the internal hardware. The door may have a door opened and a door closed position. The door may be attached to the cabinet by a hinge. The video terminal may also include a guide fixedly attached to the cabinet, and a roller movably attached to the guide, wherein the display screen is fixedly attached to the roller. The video terminal may also include a movement restriction arrangement attached to the cabinet and the door, wherein the movement restriction arrangement is configured to allow the door to move from the door opened to the door closed position at a controlled speed. The display screen may be accessibly positioned to a technician and the internal hardware is easily accessible when the display screen is in the screen opened position and the door is in the door opened position. The internal hardware and the display screen may be substantially enclosed by the cabinet and the door when the door is in the door closed position. The internal hardware may be operably connected to the display screen. The display screen may be operably connected to the door so that moving the door from the door closed position to the door opened position actuates a movement of the display screen from the screen closed to the screen opened position. The display screen may be mechanically coupled to the door and move concurrently with the door. The video terminal may be a video lottery terminal configured to dispense a lottery game ticket or a virtual slot game terminal configured to provide a virtual slot game on the display screen.

Another example embodiment of the present invention may be a video wagering machine, including a cabinet, a payment acceptor, a dispenser, a prize structure, internal hardware, a door hingedly attached to the cabinet, a set of guides fixedly attached to the cabinet, a set of rollers movably attached to the set of guides, and a display screen fixedly attached to the set of rollers and having a screen opened and a screen closed position, wherein the display screen is mechanically coupled to the door so that moving the door from the door closed position to the door opened position actuates a movement of the display screen from the screen closed to the screen opened position. The payment acceptor may be configured to accept a payment. The dispenser may be configured to dispense a prize. The prize structure may include a prize structure entry associated with a prize. The internal hardware may be substantially enclosed by the cabinet. The door may have a door opened and a door closed position.

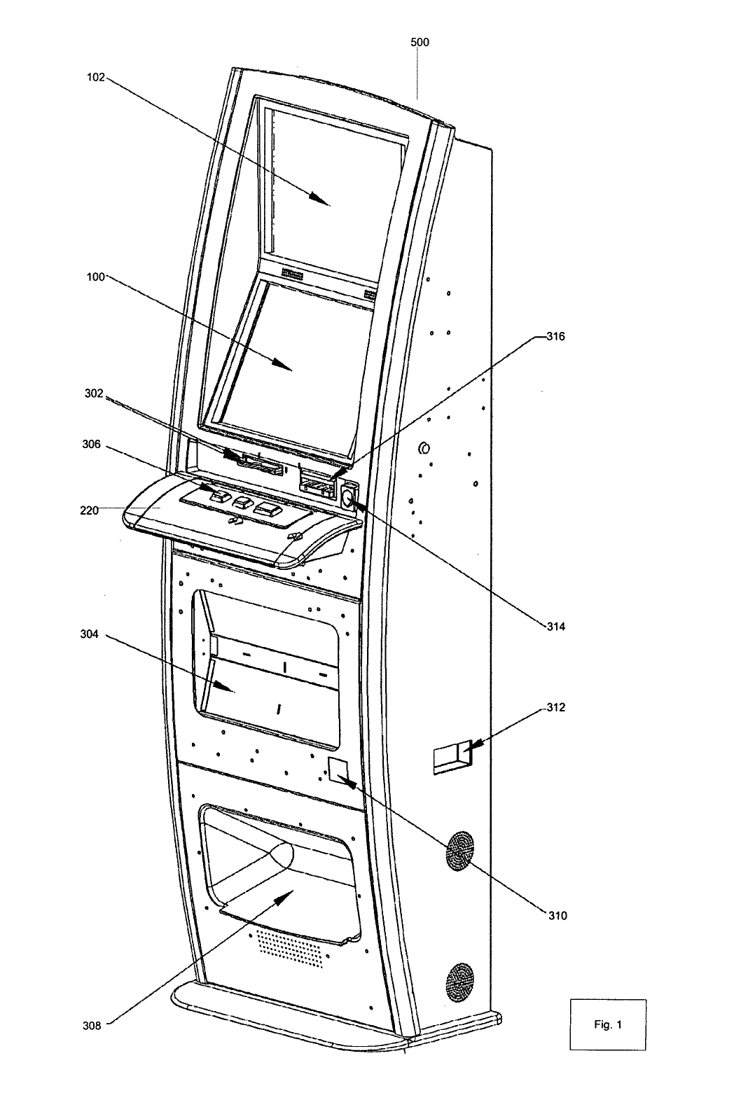

FIG. 1 depicts a perspective view of an example video game terminal in a closed position, in accordance with an embodiment of the present invention. A video game terminal 500 may be configured to provide a wagering game to a player. Alternatively, the video game terminal 500 may be configured to provide a game of chance, a lottery game, or another game to the player. For example, the game provided may be played on a display screen. The video game terminal 500 may include an upper screen 102 and a display screen 100. The upper screen 102 and display screen 100 may be configured to display information to the player. For example, the upper screen 102 and the display screen 100 may be liquid crystal display (LCD) screens. The upper screen 102 and the display screen 100 may also be a touch-sensitive screens, allowing a player to input choices by touching areas on the screens. Alternatively, the upper screen 102 and the display screen 100 may be a cathode ray tube (CRT) screen or any other type of display screen.

The video game terminal 500 may include a ticket dispenser 302. The ticket dispenser 302 may be configured dispense a ticket. For example, the ticket may be a lottery game ticket. Alternatively, the ticket may be a prize ticket redeemable for a prize or any other type of ticket. For example, the ticket may be printed on heavyweight paper.

The video game terminal 500 may include play buttons 306. The play buttons 306 may be configured to accept player input. For example, the play buttons 306 may be used by the player to interact with the wagering game by receiving selections from the player and providing the selections to the wagering game. For example, the player may select a game to be played, a wager amount to be made, and responses to choices provided by the wagering game.

The video game terminal 500 may include a button fingerboard 220. The button fingerboard 220 may serve as a hand rest for the player while playing the wagering game. The video game terminal 500 may include a bottom graphics area 304. The button fingerboard 220 and the bottom graphics area 304 may include printed graphics that attract player attention to the game or other visual designs. The button fingerboard 220 and the bottom graphics area 304 may also include printed information, such as game information or prize information.

The video game terminal 500 may include a foot rest 308. The foot rest 308 may be configured to accept the player's feet in a resting position while playing at the video game terminal.

The video game terminal 500 may include a coin dispenser 310. The coin dispenser 310 may be configured to dispense coins. For example, the coin dispenser 310 may dispense coins as change for a player's wager or a player's winnings. Alternatively, the coin dispenser 310 may be replaced with a ticket dispenser. A player's winnings may be dispensed as a ticket which may later be redeemed at a cashier.

The video game terminal 500 may include a side handle 312. The side handle 312 may be configured to allow a technician move the video game terminal 500 during installation and removal.

The video game terminal 500 may include a coin acceptor 314. The coin acceptor 314 may be configured to accept a coin. For example, the coin may be legal tender in the form of a coin or legal tender equivalents, such as tokens provided by a gaming establishment.

The video game terminal 500 may include a bill acceptor 316. The bill acceptor 316 may be configured to accept a legal tender in the form of a bill. Alternatively, the bill acceptor 316 may be configured to accept legal tender equivalents, such as bills provided by a gaming establishment. Alternatively, the bill acceptor 316 may be configured to accept a magnetic card. For example, the magnetic card may include a currency-equivalent balance. Alternatively, the bill acceptor may be configured to accept other currency-equivalents.

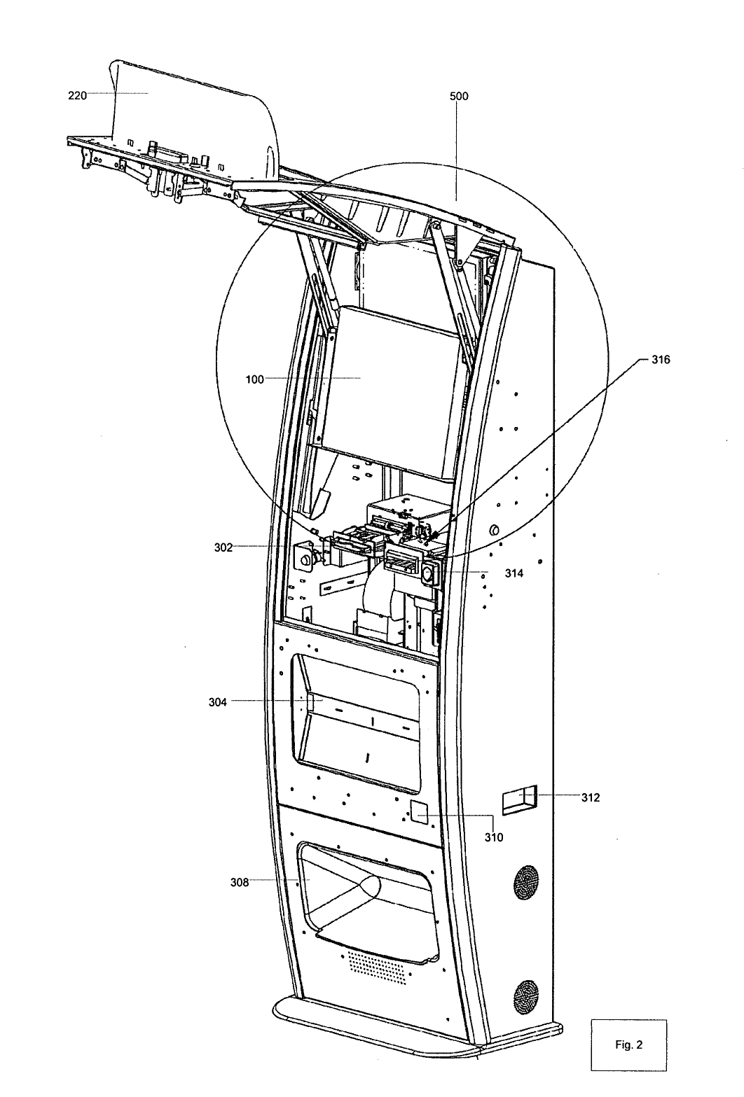

FIG. 2 depicts a perspective view of an example video game terminal in an opened position, in accordance with an embodiment of the present invention. A video game terminal 500 as depicted in FIG. 1 may be in an opened position. The display screen 100 may be exposed and in a screen open position. The screen open position may provide access to internal peripheral such as the bill acceptor 316 and the ticket dispenser 302, as described in FIG. 1.

The bottom graphics area 304, the foot rest 308, the coin dispenser 310 and the side handle 312 may be as described in FIG. 1. The video game terminal 500 may include a button fingerboard 220 as described in FIG. 1.

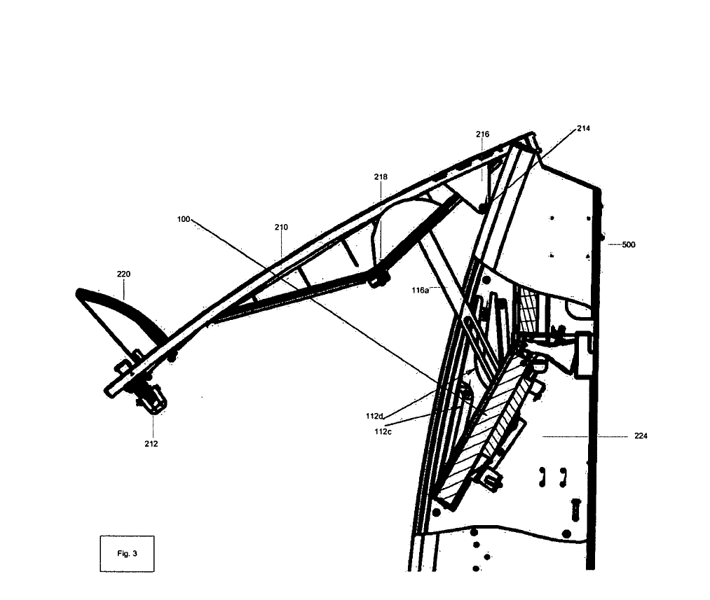

FIG. 3 depicts a side view of an example video game terminal in a half-opened position, in accordance with a first example embodiment of the present invention. The display screen 100 is substantially enclosed by a video game terminal 500 and a door 210 when the door 210 is closed. The side of the video game terminal 500 has been cut away to show the display screen 100. The display screen 100 can move up and down relative to the video game terminal 500 between a screen opened position and a screen closed position.

The video game terminal 500 may be large enough to enclose the display screen 100 and peripherals within an internal space 224. The video game terminal 500 may be physically resistant to unauthorized access. For example, the video game terminal 500 may be constructed of a strong material, such as a high density plastic or a metal alloy. The video game terminal 500 may also be configured to detect unauthorized access. For example, the video game terminal 500 may include sensors to detect an access, a controller to determine whether the access is authorized and a memory to log accesses. The controller may be connected to an input device a user may use to input a password or accept a key for authorized access. The key may be mechanical or electronic.

The door 210 may include a latch 212 at one end. The latch 212 may secure the door 210 closed when the door 210 is in a door closed position. The latch 212 may be controlled with a lock. For example, the lock may be mechanical or electronic.

The door 210 may include a gas strut pivot pin 214. The door 210 may include two gas strut pivot pins 214 located on a right and left side of the door 210. The gas strut pivot pin 214 may anchor a top end of a gas strut. The gas strut may rotate over the pin as the door 210 opens and closes. The gas strut may be retained onto the gas strut pivot pin 214 by a fastener/washer arrangement. Alternatively, a pivot-ball arrangement such as the gas strut lower mounting bracket 154 may be used. However, the gas strut pivot pin 214 arrangement with a fastener/washer requires less space.

The door 210 may also include a gas strut upper mounting bracket 216. The upper mounting bracket 216 may attach to the gas strut pivot pin 214. It may also be part of the door 210 and provide rigidity to the door 210. The gas strut upper mounting bracket 216 may be configured to position the gas strut to hold the door 210 in place when fully opened. The gas strut upper mounting bracket 216 may also be configured to position the gas strut so that it automatically pulls the door 210 closed when the door 210 has been moved to a substantially closed position. For example, a substantially closed position may be when the door 210 is within two inches of the door closed position.

The door 210 may also include a monitor bezel 218. The monitor bezel 218 may be a plastic filler part attached to the door 210 and may fill a space between the display screen 100 and the door 210. The monitor bezel 218 may border the display screen 100 when the door 210 is closed. If the display screen 100 is ever replaced with a new display screen of different dimensions, the monitor bezel 218 may be replaced with one that accommodates the new display screen.

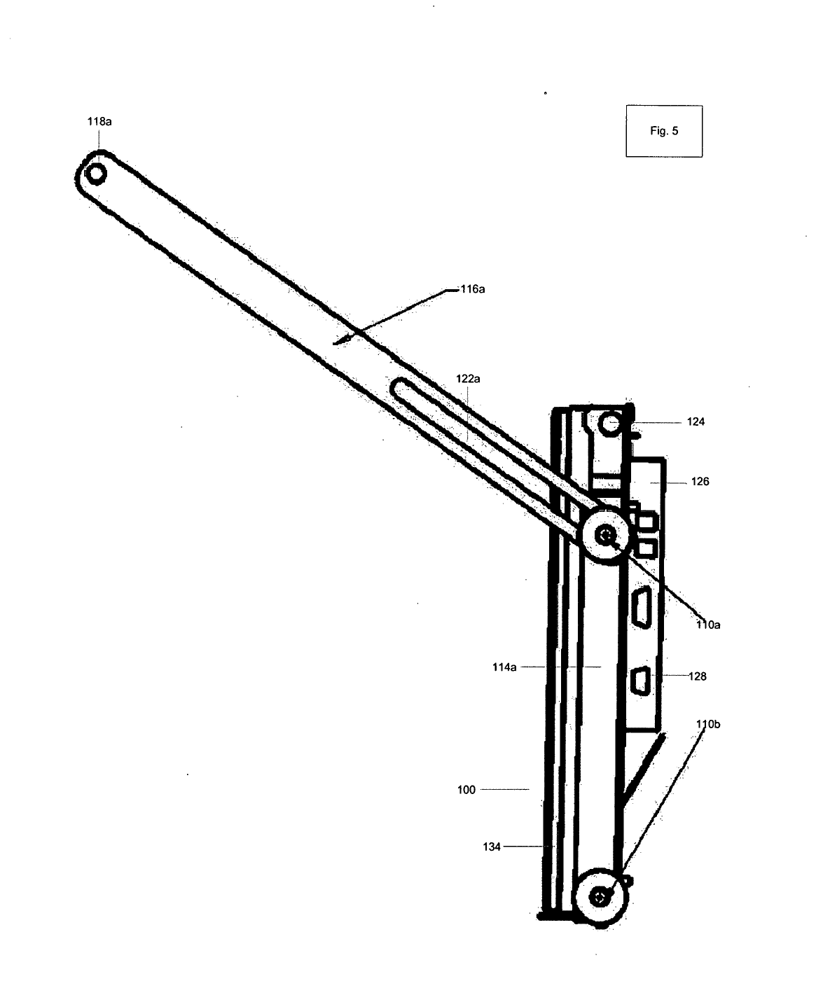

A link 116a is rotatably attached to the door 210 at one end and movably attached to the display screen 100 at the other. The link 116a may attach to the display screen 100 through a mounting bracket 114a, as depicted in FIG. 5.

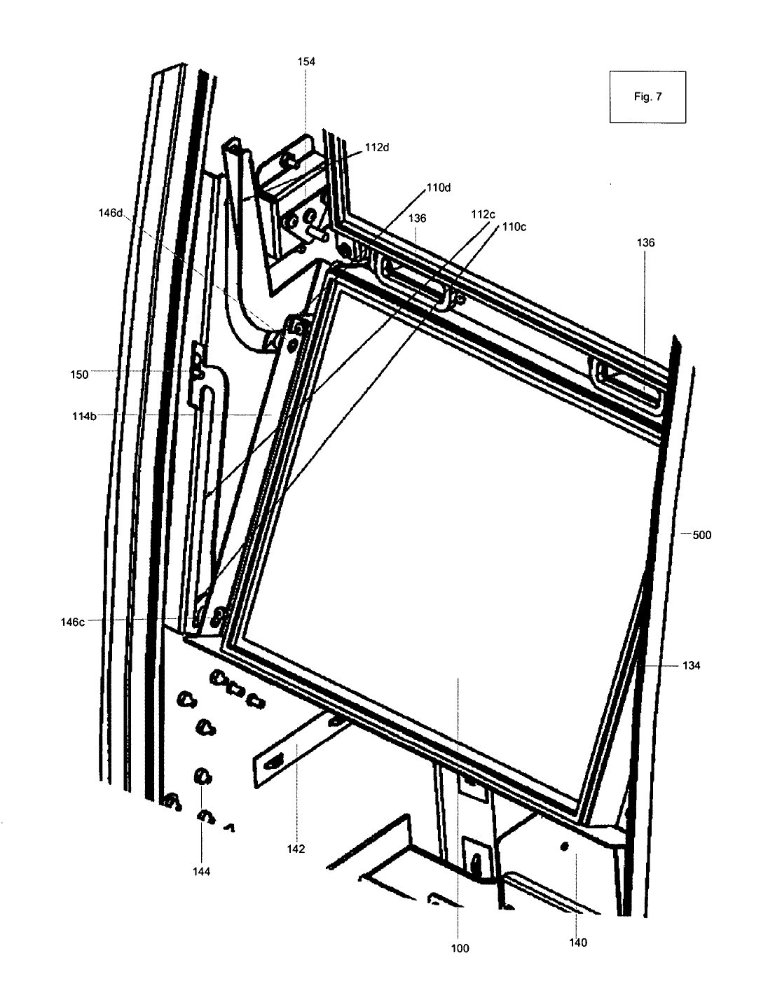

The video game terminal 500 may include a button fingerboard 220, as described in FIG. 1. The video game terminal 500 may include guides 112c and 112d, as described in FIG. 7.

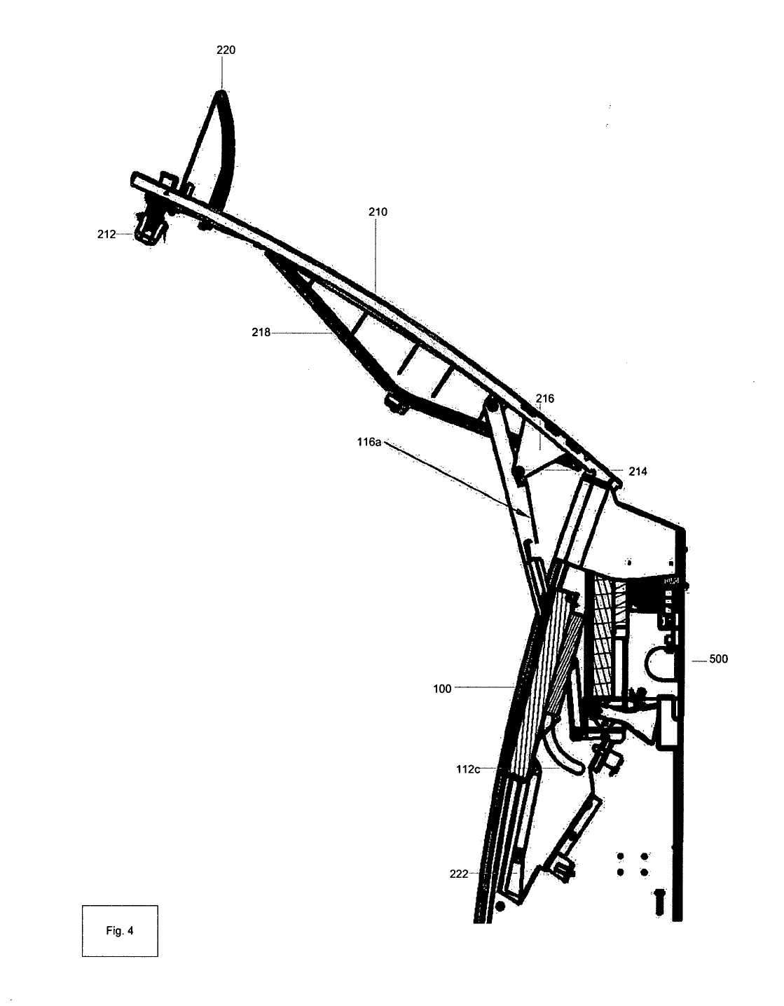

FIG. 4 depicts a side view of an example video game terminal in an opened position, in accordance with a first example embodiment of the present invention. A display screen 100 may remain accessible to a user, such as a technician, when it is in a screen opened position. When the display screen 100 is in the screen opened position, the user may be able to easily access internal peripherals located in the video game terminal 500.

The side of the video game terminal 500 has been cut away to show the display screen 100. The display screen 100 is in the screen opened position. Guides 112c and 112d may accept a roller as described in FIG. 7, allowing the display screen 100 to move between the screen opened position and the screen closed position.

The door 210 may include a latch 212 at one end. The latch 212 may secure the door 210 closed when the door 210 is in a door closed position. The latch 212 may be controlled with a lock. For example, the lock may be mechanical or electronic. The door 210 may also include a button fingerboard 220, as described in FIG. 1.

The door 210 may include a gas strut pivot pin 214. The door 210 may include two gas strut pivot pins 214 located on a right and left side of the door 210. The gas strut pivot pin 214 may anchor a top end of a gas strut. The gas strut may rotate over the pin as the door 210 opens and closes. The gas strut may be retained onto the gas strut pivot pin 214 by a fastener/washer arrangement. Alternatively, a pivot-ball arrangement such as the gas strut lower mounting bracket 154 may be used. However, the gas strut pivot pin 214 arrangement with a fastener/washer requires less space.

The door 210 may also include a gas strut upper mounting bracket 216. The upper mounting bracket 216 may attach to the gas strut pivot pin 214. It may also be part of the door 210 and provide rigidity to the door 210. The gas strut upper mounting bracket 216 may be configured to position the gas strut to hold the door 210 in place when fully opened. The gas strut upper mounting bracket 216 may also be configured to position the gas strut so that it automatically pulls the door 210 closed when the door 210 has been moved to a substantially closed position. For example, a substantially closed position may be when the door 210 is within two inches of the door closed position.

The door 210 may also include a monitor bezel 218. The monitor bezel 218 may be a plastic filler part attached to the door 210 and may fill a space between the display screen 100 and the door 210. The monitor bezel 218 may border the display screen 100 when the door 210 is closed. If the display screen 100 is ever replaced with a new display screen of different dimensions, the monitor bezel 218 may be replaced with one that accommodates the new display screen.

The link 116a may be rotatably attached to the door 210 at one end and movably attached to the display screen 100 at the other. The link 116a may attach to the display screen 100 through a mounting bracket, as depicted in FIG. 5. In FIG. 4, the link 116a has been pulled up by opening door 210. In turn, the link 116a has pulled up the display screen 100 in to the screen opened position.

FIG. 5 depicts a side view of an example display screen assembly, in accordance with an example embodiment of the present invention. The display screen assembly may include the display screen 100. The display screen assembly may also include rollers 110a and 110b. The rollers 110a and 110b may be constructed from plastic, ceramic or metal and configured to rotate freely relative to the display screen 100.

The display screen assembly may also include the mounting bracket 114a. The display screen 100, the rollers 110a and 110b and link 116a may be movably attached to the mounting bracket 114a.

The link 116a may be movably attached to the mounting bracket 114a. The link 116a may be configured to actuate the mounting bracket 114a by pulling up on it when a door 210 is opened. The mounting bracket 114a may be pulled down by gravity when the door 210 is closed. The link 116a may be configured to hold the mounting bracket 114a in an open position. For example, the link 116a may include a notch that catches the mounting bracket 114a in the open position.

The link 116a may include a connector 118a. The connector 118a may be a hole drilled in the link 116a. The connector 118a may be configured to rotatably attach to a door.

The link 116a may include a mounting slot 122a. The mounting slot 122a may be a lateral slot in the link 116a as depicted in FIG. 5. The mounting slot 112a may be configured to movably attach to the bracket assembly 114a.

The display screen 100 may be operably connected to a control box 126. For example, the control box 126 may be configured to provide controls for the display screen 100. The control box 126 may include a plurality of connectors 128. The connectors 128 may be configured to interface to other components in the video game terminal. For example, the connectors 128 may receive plugs attached to wires or cables such as power cables or data cables.

The display screen 100 may be retained in a display screen housing 134. The display screen housing 134 may include plungers 124 (only one is depicted). The plungers 124 may be configured to retain the display screen 100 in the display screen housing 134.

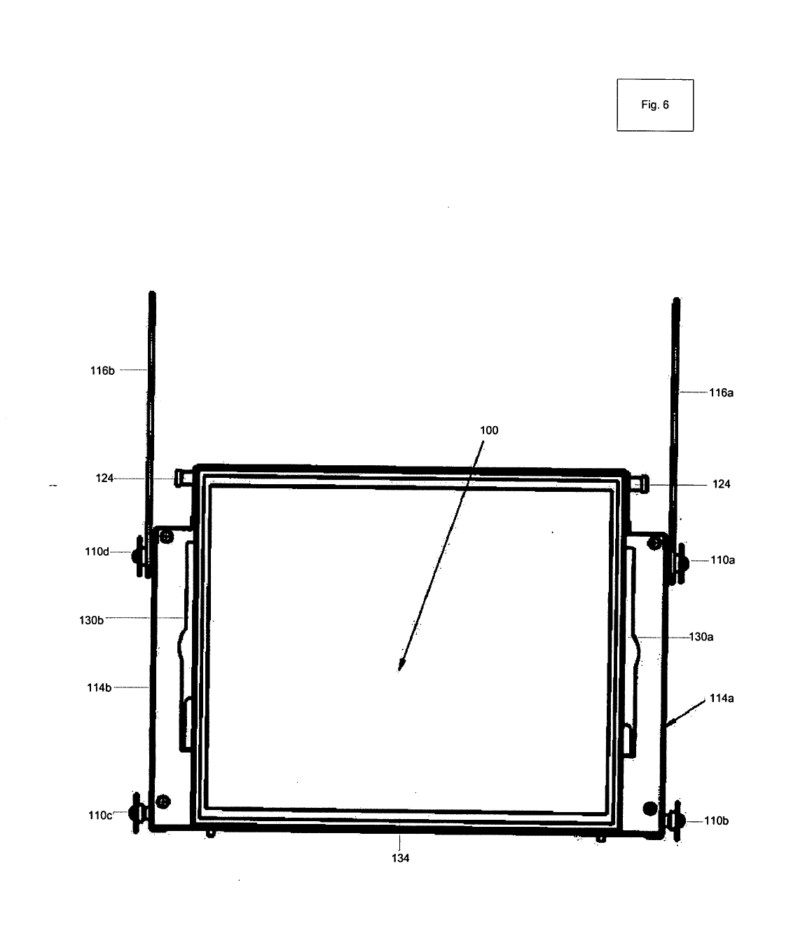

FIG. 6 depicts a front view of an example display screen assembly, in accordance with an example embodiment of the present invention. The display screen assembly may be as depicted in FIG. 5 and include the display screen 100. The display screen assembly may also include rollers 110a, 110b, 110c and 110d. The rollers 110a, 110b, 110c and 110d may be constructed from plastic, ceramic or metal and configured to rotate freely relative to the display screen 100.

The display screen 100 may be retained in a display screen housing 134. The display screen housing 134 may include plungers 124. The plungers 124 may be configured to retain the display screen 100 in the display screen housing 134.

The display screen assembly may also include mounting brackets 114a and 114b. The display screen 100, the rollers 110a, 110b, 110c and 110d and links 116a and 116b may all be movably attached to the mounting brackets 114a and 114b.

The links 116a and 116b may be movably attached to the mounting brackets 114a and 114b. The links 116a and 116b may be configured to actuate the mounting brackets 114a and 114b by pulling up on it when a door 210 is opened. The mounting bracket 114a may be pulled down by gravity when the door 210 is closed. The link 116a may be configured to hold the mounting bracket 114a in an open position. For example, the links 116a and 116b may each include a notch that catches the mounting bracket 114a in the open position.

The mounting brackets may include stamping cut outs 130a and 130b. The stamping cut outs 130a and 130b may be openings that allow components of the display screen 100 (such as cables and control boards to protrude. This prevents interferences when the display screen 100 is placed in the mounting brackets 114a and 114b. The stamping cut outs 130a and 130b may be a hole or a cut-out.

FIG. 7 depicts a perspective view of an example display screen in a closed position within an example video game terminal without a door, in accordance with an embodiment of the present invention. A video game terminal 500 may enclose a display screen 100. The display screen 100 may be configured to display graphics and text. For example, the display screen 100 may be a liquid crystal display (LCD) screen or a plasma screen. Alternatively, the display 100 may be a touch-sensitive screen accepting inputs from a user through touching the screen. The display screen 100 may be enclosed by a display screen housing 134. Speaker holes 136 may be placed above the display screen 100 to allow sounds to emanate from speakers located behind the speaker holes 136.

The display screen 100 may be mechanically coupled to the video game terminal 500. The display screen 100 may be fixedly mounted on a mounting bracket 114b. The mounting bracket 114b may include rollers 110c and 110d configured to rotate relative to the mounting bracket 114b and the display screen 100. The rollers 110c and 110d may be constructed from plastic, ceramic or metal. The rollers 110c and 110d may fit within guides 112c and 112d. This allows the display screen 100 to move along the guides 112c and 112d with minimum friction. The guides 112c and 112d may be mounted to the video game terminal 500 by mounting stud 150. The rollers 110c and 110d may be attached to the mounting bracket 114b by roller mounting fasteners 146c and 146d.

The display screen 100 may be configured for two positions, a screen closed position, as depicted in FIG. 1 or a screen opened position, as depicted in FIG. 2. In the screen closed position, the display screen 100 is in its normal operating position. In the screen opened position, the display 100 is up and allows access to a space for internal hardware 140. The space for internal hardware 140 may contain internal hardware operably connected to the display screen 100. For example, a technician may access the space for internal hardware to maintain or upgrade the video terminal.

Alternatively, any mechanical coupling that allows the display screen 100 to move up and down relative to the body 500 from the screen closed position to the screen opened position may be used.

The display screen 100 may be moved from the closed position to the opened position by the technician accessing the terminal. The technician may push the display screen 100 into the screen opened position to access the space for internal hardware 140 and push the display screen 100 into the screen closed position when he is finished.

The video game terminal 500 may include a harness retention lance 142. The harness retention lance 142 may be one of many throughout the terminal. The harness retention lance 142 may be configured to provide structural support for the video game terminal 500 and to attach various components to the video game terminal 500.

The video game terminal 500 may include mounting stud 144. The mounting stud 144 may be one of many throughout the terminal. The mounting stud 144 may be configured to provide structural support for the video game terminal 500 and to attach various components to the video game terminal 500.

The video game terminal 500 may include a gas strut lower mounting bracket 154. The gas strut lower mounting bracket 154 may be a triangular shaped plate with an attached pivot-ball. The gas strut lower mounting bracket 154 may attach to the side of the cabinet 500 and serve as an anchor point for the gas strut upper mounting bracket 216. Gas struts may be retained by snapping a bottom end of the struts over the ball of the gas strut lower mounting bracket 154. The gas strut lower mounting bracket 154 may function like a coupling; it allows the strut to rotate over the ball as the door opens and closes.

The video game terminal 500 may include a movement restriction arrangement attached to the cabinet and the door. The movement restriction arrangement may be configured to allow the door to move from the door opened to the door closed position at a controlled speed. For example, the movement restriction arrangement may be a hydraulic system.

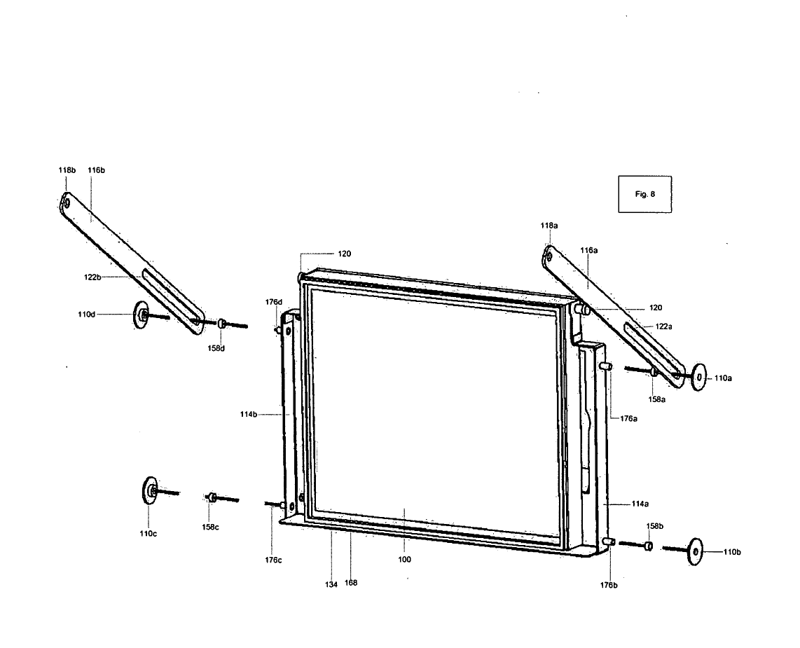

FIG. 8 depicts an exploded perspective view of an example display screen assembly, in accordance with an example embodiment of the present invention. The display screen assembly may include the display screen 100. The display screen assembly may also include rollers 110a, 110b, 110c and 110d. The rollers 110a, 110b, 110c and 110d may be constructed from plastic, ceramic or metal and configured to rotate freely relative to the display screen 100.

The display screen assembly may also include mounting brackets 114a and 114b. The display screen 100, the rollers 110a, 110b, 110c and 110d and links 116a and 116b may all be attached to the mounting brackets 114a and 114b.

The links 116a and 116b may be movably attached to the mounting brackets 114a and 114b. The links 116a and 116b may be configured to actuate the mounting brackets 114a and 114b by pulling up and pushing down on it. This action may move the display screen 100 up into a screen opened position or down into a screen closed position.

The link 116a may include a door mounting hole 118a. The door mounting hole 118a may be configured to movably attach to a door. The link 116a may include a screen mounting slot 122a. The screen mounting slot 122a may be configured to movably attach to the mounting bracket 114a. Similarly, the link 116b may include a door mounting hole 118b and a screen mounting slot 122b.

The roller 110a may be attached to a spacer collar 158a, which is in turn attached to a roller mounting shaft 176a. The roller 110a may be configured to rotate relative to the mounting bracket 114a.

Likewise, the roller 110b may be similarly attached to the mounting bracket 114a by a spacer collar 158b and a roller mounting shaft 176b. The 110c may be similarly attached to the mounting bracket 114b by a spacer collar 158c and a roller mounting shaft 176c. The 110d may be similarly attached to the mounting bracket 114b by a spacer collar 158d and a roller mounting shaft 176d.

The display screen 100 may be enclosed in a screen housing 134. If the display screen 100 is a touch-sensitive screen, the display screen 100 may include a touch screen tape 168. A touch-sensitive screen may include a touch screen tape 168 and a LCD screen. The touch screen tape 168 may fasten the touch-sensitive screen to a LCD screen.

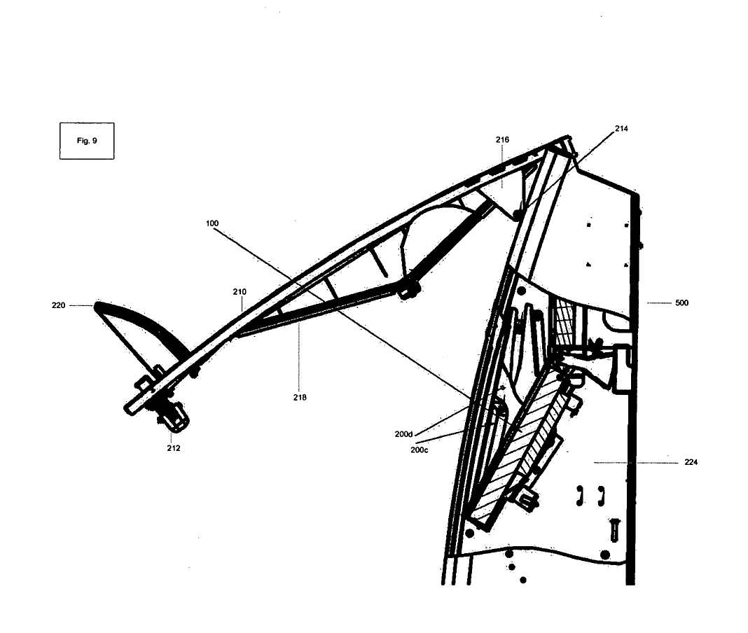

FIG. 9 depicts a side view of a second example video terminal in a half-opened position, in accordance with a second example embodiment of the present invention. The second example embodiment depicted in FIG. 9 may be similar to the first example embodiment depicted in FIG. 3, except the second example embodiment omits the link 116a. In the second example embodiment, a movement of the display screen 100 may not be coupled to a movement of the door 210. A user, such as a technician, may first open the door 210 into an opened position, then push the display screen 100 up into an opened position.

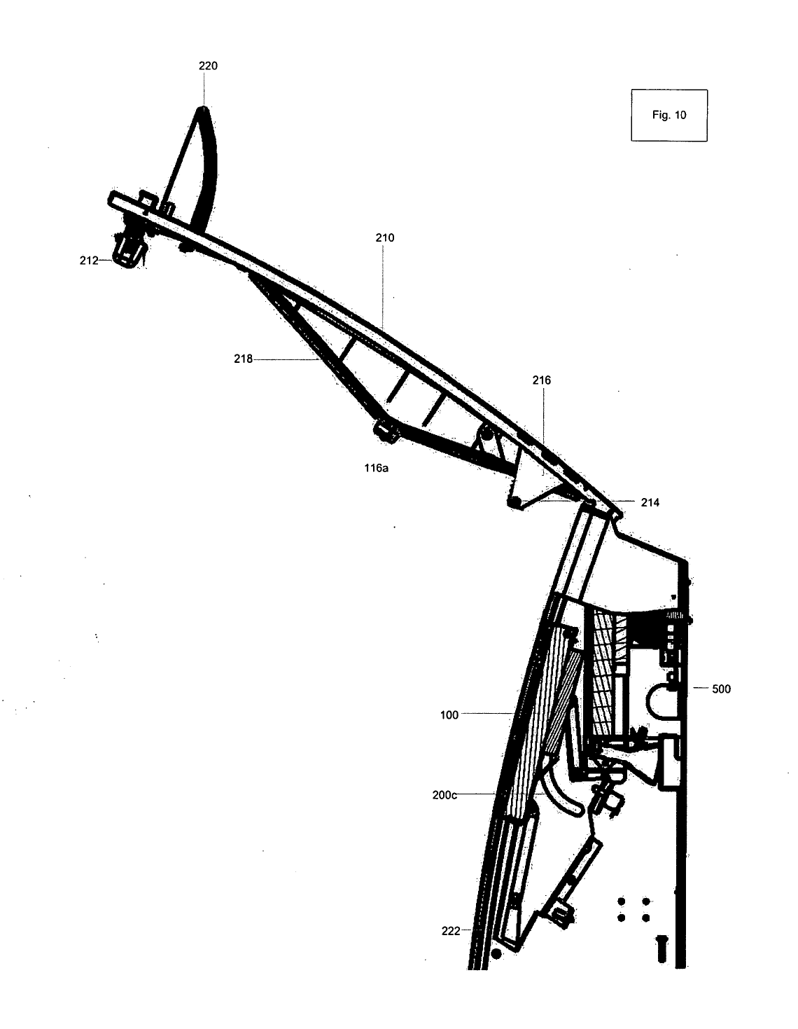

FIG. 10 depicts a side view of a second example video game terminal in an opened position, in accordance with a second example embodiment of the present invention. The second example embodiment depicted in FIG. 10 may be similar to the first example embodiment depicted in FIG. 4, except the second example embodiment omits the link 116a. In the second example embodiment, a movement of the display screen 100 may not be coupled to a movement of the door 210. A user, such as a technician, may first open the door 210 into an opened position, then push the display screen 100 up into an opened position.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A video terminal, comprising:
internal hardware;
a cabinet, the cabinet enclosing the internal hardware;
a door movably attached to the cabinet, the door having a door opened and a door closed position; and
a display screen movably attached to the cabinet separately from the door and having a screen opened and a screen closed position.

2. A terminal of claim 1, wherein the door is attached to the cabinet by a hinge.

3. A terminal of claim 1, further comprising,
a guide fixedly attached to the cabinet; and
a roller movably attached to the guide, wherein the display screen is fixedly attached to the roller.

4. A terminal of claim 1, further comprising,
a movement restriction arrangement attached to the cabinet and the door, wherein the movement restriction arrangement is configured to allow the door to move from the door opened to the door closed position at a controlled speed.

5. A terminal of claim 1, wherein the display screen is accessibly positioned to a technician and the internal hardware is easily accessible when the display screen is in the screen opened position and the door is in the door opened position.

6. A terminal of claim 1, wherein the internal hardware and the display screen are substantially enclosed by the cabinet and the door when the door is in the door closed position.

7. A terminal of claim 6, wherein the internal hardware is operably connected to the display screen.

8. A terminal of claim 1, wherein the display screen is operably connected to the door so that moving the door from the door closed position to the door opened position actuates a movement of the display screen from the screen closed to the screen opened position.

9. A terminal of claim 8, wherein the display screen is mechanically coupled to the door.

10. A terminal of claim 8, wherein the display screen moves concurrently with the door.

11. A terminal of claim 1, wherein the terminal is a video lottery terminal configured to dispense a lottery game ticket.

12. A terminal of claim 1, wherein the terminal is a virtual slot game terminal configured to provide a virtual slot game on the display screen.

13. A video wagering machine, comprising:
a cabinet;
a payment acceptor, the payment acceptor configured to accept a payment;
a dispenser, the dispenser configured to dispense a prize;
a prize structure, the prize structure including a prize structure entry associated with a prize;
internal hardware, the internal hardware substantially enclosed by the cabinet;
a door hingedly attached to the cabinet, the door having a door opened and a door closed position;
a set of guides fixedly attached to the cabinet;
a set of rollers movably attached to the set of guides; and
a display screen fixedly attached to the set of rollers and having a screen opened and a screen closed position, wherein the display screen is mechanically coupled to the door so that moving the door from the door closed position to the door opened position actuates a movement of the display screen from the screen closed to the screen opened position.
